(19) United States
(12) Patent Application Publication
(10) Pub. No.: US 2025/0317873 A1
(43) Pub. Date: Oct. 9, 2025

(54) SYSTEMS AND METHODS FOR ADAPTIVE TRANSMIT POWER CONTROL IN A WIRELESS COMMUNICATION DEVICE

(71) Applicant: HFCL Limited, Devarabeesanahalli (IN)

(72) Inventor: Subhas Chandra MONDAL, Bangalore (IN)

(73) Assignee: HFCL Limited, Devarabeesanahalli (IN)

(21) Appl. No.: 19/172,986

(22) Filed: Apr. 8, 2025

(30) Foreign Application Priority Data
Apr. 9, 2024 (IN) 202441028994

(51) Int. Cl. H04W 52/52; H04L 1/00

(52) U.S. Cl. CPC H04W 52/52; H04L 1/0003; H04L 1/0009

(57) ABSTRACT

Systems and methods for adaptive transmit power control in a wireless communication device are described. In particular, the method includes setting a power level of a baseband signal at a baseband subsystem, setting a power level of a digital frontend (DFE) radio frequency (RF) signal at a DFE subsystem, setting a gain of a variable gain amplifier (VGA) at a RF FE subsystem, and optimizing a transmit power of the system based on adaptively controlling the power level of the baseband signal, the power level of the DFE RF signal, and the gain of the VGA to meet a target error vector magnitude (EVM) for a corresponding modulation and coding scheme (MCS) value.

### TECHNICAL FIELD

The present disclosure, in general, relates to managing power in a wireless communication network, and in particular, relates to systems and methods for adaptive transmit power control in a wireless communication device, for example, a base station.

### BACKGROUND

Unlicensed band radio may use 802.11 based implementation or a proprietary implementation under the prevailing regulatory compliance. In all such implementation approaches, in-channel interference mitigation techniques like channel switching are well documented. While the standards provide well documented radio frequency (RF) characteristics from compliance point of view, interference management remains vastly in the realm of implementation novelties. In a wireless radio transceiver system, there are two types of interferences, 1) In-band and 2) out of band. Out of band interference is handled by an Analog RF filter that is a well-known practice. However, in-band interference management has its own challenges. There are two types of in-band interference that influence receiver performance: 1) Adjacent channel interference, 2) In channel interference. Assuming in-channel interference is addressed adequately, dealing with adjacent channel interference is becoming a key factor that will influence the link performance of a transceiver system. In a wireless channel, in presence of noise, the signal strength plays a key role in determining the signal to interfere and noise ratio (SINR). If the signal power is low under a constant in-channel interference and the adjacent channel selectivity is good (meaning that the adjacent channel interference is rejected adequately), even though the wanted signal is not under the influence of noise from an interferer, the SINR will be low. Hence, the immunity of the signal is a function of the receive signal strength.

The new generation wireless networks based on Wi-Fi6 (802.11ax) or Wi-Fi7 (802.11be) specifications use orthogonal frequency division multiple access (OFDMA) based modulation and multiple access schemes. High peak to average power ratio (PAPR) of OFDM signal is a well-known problem from RF transceiver design point of view. To ensure orthogonality of OFDM symbols, the RF power amplifier needs to operate linearly in a very wide range of power levels for a given average power of the channel. The PAPR problem worsens as the data rate of the channel in increased by usage of higher order modulation and coding scheme (MCS).

As an example, data rate for MCS11 may be higher than that of MCSO. Hence, it is always desirable to make MCS11 work for maximum throughput. The table (A) shows an analysis of minimum receive power requirements for different MCS values for an 80 MHz channel.

TABLE A

| | | Receiver sensitivity | Receiver sensitivity |
|---|---|---|---|
| MCS value | Modulation | for 80 MHz channel | difference |
| 0 | BPSK ½ | −76 | 0 |
| 1 | QPSK ½ | −73 | +3 |
| 2 | QPSK ¾ | −71 | +5 |
| 3 | 16QAM ½ | −68 | +8 |
| 4 | 16QAM ¾ | −64 | +12 |
| 5 | 64QAM ⅔ | −60 | +16 |
| 6 | 64QAM ¾ | −59 | +17 |
| 7 | 64QAM ⅚ | −58 | +18 |
| 8 | 256QAM ¾ | −53 | +23 |
| 9 | 256QAM ⅚ | −51 | +25 |
| 10 | 1024QAM ¾ | −48 | +28 |
| 11 | 1024QAM ⅚ | −46 | +30 |

If power level was 24 dBm for all MCS values, the permissible pathloss would have been as per the table (B) below:

TABLE B

| | | | Max permissible | Receiver | |
|---|---|---|---|---|---|
| | | | Pathloss for Rx | sensitivity | Receiver |
| MCS | | Tx | power to be above | for 80 MHz | sensitivity |
| value | Modulation | power | Rx sensitivity | channel | difference |
| 0 | BPSK ½ | 24 | 100 | −76 | 0 |
| 1 | QPSK ½ | 24 | 97 | −73 | +3 |
| 2 | QPSK ¾ | 24 | 95 | −71 | +5 |
| 3 | 16QAM ½ | 24 | 92 | −68 | +8 |
| 4 | 16QAM ¾ | 24 | 88 | −64 | +12 |
| 5 | 64QAM ⅔ | 24 | 84 | −60 | +16 |
| 6 | 64QAM ¾ | 24 | 83 | −59 | +17 |
| 7 | 64QAM ⅚ | 24 | 82 | −58 | +18 |
| 8 | 256QAM ¾ | 24 | 77 | −53 | +23 |
| 9 | 256QAM ⅚ | 24 | 75 | −51 | +25 |
| 10 | 1024QAM ¾ | 24 | 72 | −48 | +28 |
| 11 | 1024QAM ⅚ | 24 | 70 | −46 | +30 |

Since the power level needs to be reduced for higher MCS to deal with PAPR, the below table (C) shows permissible pathloss with appropriate power reduction.

TABLE C

| | | | Max permissible | Receiver | |
|---|---|---|---|---|---|
| | | | Pathloss for Rx | sensitivity for | Receiver |
| MCS | | Tx | power to be above | 80 MHz | sensitivity |
| value | Modulation | power | Rx sensitivity | channel | difference |
| 0 | BPSK ½ | 24 | 100 | −76 | 0 |
| 1 | QPSK ½ | 24 | 97 | −73 | +3 |
| 2 | QPSK ¾ | 24 | 95 | −71 | +5 |
| 3 | 16QAM ½ | 24 | 92 | −68 | +8 |
| 4 | 16QAM ¾ | 21 | 85 | −64 | +12 |
| 5 | 64QAM ⅔ | 21 | 81 | −60 | +16 |
| 6 | 64QAM ¾ | 21 | 80 | −59 | +17 |
| 7 | 64QAM ⅚ | 21 | 79 | −58 | +18 |
| 8 | 256QAM ¾ | 18.5 | 71.5 | −53 | +23 |
| 9 | 256QAM ⅚ | 18.5 | 69.5 | −51 | +25 |
| 10 | 1024QAM ¾ | 18.5 | 66.5 | −48 | +28 |
| 11 | 1024QAM ⅚ | 18.5 | 64.5 | −46 | +30 |

Therefore, for higher order modulation to work, the received power level needs to be higher. As an example, there is a need for 30 dB more power for MCS11 as compared to MCSO. This means, higher order modulation will work when the distance between the transmitter and receiver is less to ensure the received signal is above the receiver sensitivity for the corresponding MCS value. Further, since the transmit power level for higher MCS is reduced to address PAPR issue, it impacts maximum permissible pathloss and hence the distance between transmitter and receiver needs to be reduced to make the same MCS work. Furthermore, the reduction in power makes the signal susceptible to interference and hence the performance of the link degrades.

Therefore, there is a need for an adaptive power management approach to achieve highest MCS value while meeting the spectrum emission mask. If the power level for higher MCS is increased in the transmitter side, different subsystems may enter the non-linear region and hence the EVM will degrade slowly. Accordingly, there is a need to arrive at an optimal gain setting at each subsystem level and arrive at the most optimal trade-off between the transmit power level and EVM for the highest achievable MCS value. Increase in power level may cause spurious emission and may violate spectrum emission mask. Hence, there is a need for intelligent power management to enhance spectrum efficiency without violating the spectrum emission mask and attaining highest MCS value. Further, there is a need for a mechanism to linearize amplifiers at different subsystem levels so that same power level can be maintained preferably for all MCS.

The existing systems do not provide a technique whereby highest MCS value is achieved without making any subsystem to go into the non-linear region. Thus, there is a need for an intelligent system and method thereof to linearize the amplifiers at different subsystem levels so that same power level can be maintained preferably for all MCS. Also, there is a need for an adaptive power management approach to achieve highest MCS value without impacting spectrum emission mask and EVM requirements.

### Objects of the Present Disclosure

It is an object of the present disclosure to provide a system and a method for adaptive transmit power control.

It is an object of the present disclosure to provide a system and a method to achieve highest MCS value while meeting the spectrum emission mask.

It is an object of the present disclosure to provide a system and a method to arrive at an optimal gain setting at each subsystem level and arrive at the most optimal trade-off between the transmit power level and EVM for the highest achievable MCS value.

It is an object of the present disclosure to provide a system and a method to linearize amplifiers at different subsystem levels so that same power level can be maintained preferably for all MCS.

### SUMMARY

In an aspect, the present disclosure relates to a method adaptive transmit power control in a radio transceiver system, including setting, by a controller associated with the radio transceiver system, a power level of a baseband signal at a baseband subsystem of the radio transceiver system, setting, by the controller, a power level of a digital frontend (DFE) radio frequency (RF) signal at a DFE subsystem of the radio transceiver system, setting, by the controller, a gain of a variable gain amplifier (VGA) at a RF FE subsystem of the radio transceiver system, and optimizing, by the controller, a transmit power of the radio transceiver system based on adaptively controlling the power level of the baseband signal, the power level of the DFE RF signal, and the gain of the VGA to meet a target error vector magnitude (EVM) for a corresponding modulation and coding scheme (MCS) value.

In an embodiment, the transmit power may be based on at least the power level of the DFE RF signal, the gain of the VGA, and an effective fixed gain of the RF FE subsystem.

In an embodiment, optimizing, by the controller, the transmit power may include increasing, by the controller, the power level of the baseband signal.

In an embodiment, optimizing, by the controller, the transmit power may include determining, by the controller, the transmit power for highest MCS value, computing, by the controller, available power headroom based on a receiver power value and a receiver sensitivity value for the corresponding MCS value, and modifying, by the controller, the transmit power based on the available power headroom.

In an embodiment, if the available power headroom for the highest MCS value is positive, the method may include reducing, by the controller, the transmit power of the radio transceiver system by increasing the power level of the baseband signal.

In an embodiment, if the available power headroom for the highest MCS value is negative, the method may include determining, by the controller, a maximum MCS value that meets the receiver sensitivity value, and dynamically optimizing, by the controller, the transmit power by modifying the power level of the baseband signal, the power level of the DFE RF signal, and the gain of the VGA.

In an embodiment, the method may be performed during initialization of the radio transceiver system.

In an embodiment, setting, by the controller, the power level of the baseband signal may include determining, by the controller, a range of power values at the baseband subsystem where EVM is minimum, and setting, by the controller, the power level of the baseband signal as the highest power level in the range of power values corresponding to the minimum EVM.

In an embodiment, setting, by the controller, the power level of the DFE RF signal may include determining, by the controller, a range of power values at the DFE subsystem where EVM is minimum, and setting, by the controller, the power level of the DFE RF signal as the highest power level in the range of power values corresponding to the minimum EVM.

In an embodiment, the method may include monitoring, by the controller, link performance of the radio transceiver system, determining, by the controller, whether the link performance is below a predetermined threshold value, and in response to determining that the link performance is below the predetermined threshold value, identifying, by the controller, a condition to re-optimize the transmit power of the radio transceiver system, or in response to determining that the link performance exceeds the predetermined threshold value, continuing, by the controller, to monitor the link performance.

In an embodiment, in response to identifying, by the controller, the condition to re-optimize the transmit power, the method may include monitoring, by the controller, a traffic condition corresponding to the radio transceiver system, determining, by the controller, whether the traffic condition is below a traffic threshold value, and in response to determining that the traffic condition is below the traffic threshold value, re-optimizing, by the controller, the transmit power of the radio transceiver system, or in response to determining that the traffic condition exceeds the traffic threshold value, continuing, by the controller, to monitor the traffic condition.

In an embodiment, the method may be performed during run time of the radio transceiver system.

In another aspect, the present disclosure relates to a system for adaptive transmit power control, including a controller, and memory operatively coupled to the controller, wherein the memory includes instructions which, when executed by the controller, cause the controller to set a power level of a baseband signal at a baseband subsystem of the system, set a power level of a digital frontend (DFE) radio frequency (RF) signal at a DFE subsystem of the system, set a gain of a variable gain amplifier (VGA) at a RF FE subsystem of the system, and optimize a transmit power of the system based on adaptively controlling the power level of the baseband signal, the power level of the DFE RF signal, and the gain of the VGA to meet a target error vector magnitude (EVM) for a corresponding modulation and coding scheme (MCS) value.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example system architecture of a radio transceiver system, in accordance with an embodiment of the present disclosure.

FIG. 2 illustrates a flow diagram of an example method for determining an optimal gain setting to minimize error vector magnitude (EVM) for a baseband processor subsystem, in accordance with an embodiment of the present disclosure.

FIG. 3 illustrates a flow diagram of an example method for determining an optimal gain setting to minimize EVM for a digital front end (DFE) subsystem, in accordance with an embodiment of the present disclosure.

FIG. 4 illustrates a flow diagram of an example method for determining an optimal gain setting to minimize EVM for a radio frequency front end (RFFE) subsystem, in accordance with an embodiment of the present disclosure.

FIG. 5 illustrates a flow diagram of an example method for adaptive transmit power control in a radio transceiver system, in accordance with an embodiment of the present disclosure.

FIG. 6 illustrates an example computer system in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

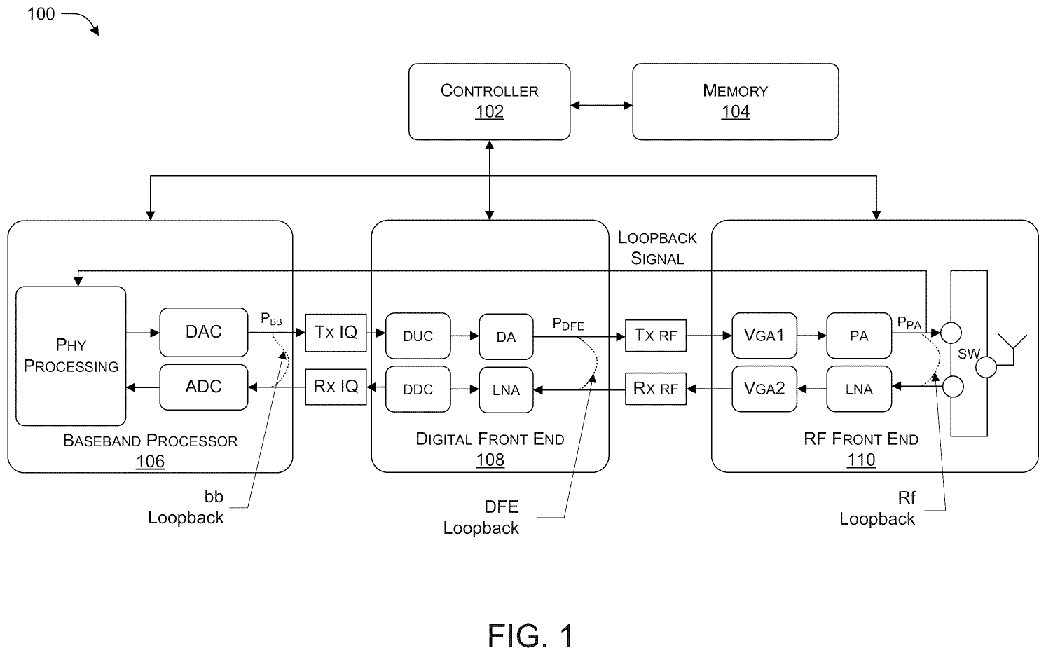

The various embodiments throughout the disclosure will be explained in more detail with reference to FIGS. 1-6.

FIG. 1 illustrates an example system architecture of a radio transceiver system (100), in accordance with an embodiment of the present disclosure.

In particular, the radio transceiver system (100) may include a controller (102), memory (104), and three subsystems. The three subsystems may include a baseband processor subsystem (106), a digital front end (DFE) subsystem (108), and a radio frequency (RF) front end (FE) subsystem (110). Referring to FIG. 1, the baseband processor (106) receives data from Medium Access Control (MAC) layer for transmission in the downlink. The baseband processor subsystem (106) adds additional information in a physical layer frame, performs error correction coding, modulates the bit stream, maps the modulated information in the frequency domain radio resources, and converts it in the time domain signal in the form of IQ samples. A Digital to Analog Converter (DAC) in the baseband processor subsystem (106) converts it into a baseband RF signal in analog form and passes it on to RFIC subsystem to perform the next stage of processing. The RFIC converts the baseband IQ signal into a carrier upconverted signal based on the channel centre frequency as per the channel parameters. This carrier upconverted signal goes to the analog RF FE (110) where the signal is amplified as per the power settings for the channel. It may be appreciated that the RFIC may be interchangeably referred as DFE.

All the three subsystems have non-linear components that may impair the signal quality that will manifest in the form of error vector magnitude (EVM). The baseband signal is converted in an analog RF signal with a small amplifier stage to drive signal to the RFIC block. The RFIC also has a driver amplifier stage to deliver the carrier upconverted signal to the RF FE subsystem (110). The amplifiers in each subsystem may experience non-linear behaviour when the power level is high. The EVM may be influenced by the linearity of each subsystem. There is an upper limit for the EVM for each modulation scheme. It may be appreciated that these upper limits are specified in 802.11AX table 27-49.

If the transmit power level is reduced, the EVM is required to be better as the power headroom in the linear region is high enough to accommodate the power backoff required to address the peak to average power ratio (PAPR) issue. However, reduction of transmit power may limit the distance between the transmitter and the receiver. Hence, the controller/system (102) may need to arrive at a trade-off to deliver highest possible Modulation and Coding Scheme (MCS) value for a given distance considering the constraints in the subsystem specifications. In an example embodiment, the EVM expected for MCS 7 is below −27 dBm or 4.4%. The below table 1 is a representation of the permissible EVM in percentage terms.

TABLE 1

| | | | | | Relative | Relative | Relative |
|---|---|---|---|---|---|---|---|
| | | | | Relative | constellation | constellation | constellation |
| | | | | constellation | error in an HE | error in an HE | error in an HE |
| | | Relative | Relative | error in an HE | TB PPDU | TB PPDU | TB PPDU |
| | | constellation error | constellation | TB PPDU when | when Tx | when Tx | when Tx |
| | | in an HE SU/HE | error in an HE | Tx power > max | power > max | power <= max | power <= max |
| | | ER/HE MU PPDU | SU/HE ER/HE | power of MCS 7 | power of MCS | power of MCS | power of MCS |
| MCS value | Modulation | (dB) | MU PPDU (%) | (dB) | 7 (%) | 7 (dB) | 7 (%) |
| 0 | BPSK ½ | −5 | 56.23 | −13 | 22.39 | −27 | 4.47 |
| 1 | QPSK ½ | −10 | 31.62 | −13 | 22.39 | −27 | 4.47 |
| 2 | QPSK ¾ | −13 | 22.39 | −13 | 22.39 | −27 | 4.47 |
| 3 | 16QAM ½ | −16 | 15.85 | −16 | 15.85 | −27 | 4.47 |
| 4 | 16QAM ¾ | −19 | 11.22 | −19 | 11.22 | −27 | 4.47 |
| 5 | 64QAM ⅔ | −22 | 7.94 | −22 | 7.94 | −27 | 4.47 |
| 6 | 64QAM ¾ | −25 | 5.62 | −25 | 5.62 | −27 | 4.47 |
| 7 | 64QAM ⅚ | −27 | 4.47 | −27 | 4.47 | −27 | 4.47 |
| 8 | 256QAM ¾ | −30 | 3.16 | −30 | 3.16 | −30 | 3.16 |
| 9 | 256QAM ⅚ | −32 | 2.51 | −32 | 2.51 | −32 | 2.51 |
| 10 | 1024QAM ¾ | −35 | 1.78 | −35 | 1.78 | −35 | 1.78 |
| 11 | 1024QAM ⅚ | −35 | 1.78 | −35 | 1.78 | −35 | 1.78 |

In an example embodiment, the below table 2 is a gain plot for an amplifier at different output power levels. The gain reduces rapidly as the output power increases beyond 31 dB. 1 dB compression point or P1 dB is the linear region of the amplifier. From 10 dB to 26 dB, the gain is flat and hence best EVM in this region can be expected. It can be inferred that the EVM may be good even when the signal is below 10 dB, provided the noise floor of this subsystem is significantly below 10 dBm of power.

TABLE 2

| Pₒᵤₜ (dBm) | Gain (dB) |
|---|---|
| 10 | 10 |
| 15 | 10 |
| 20 | 10 |
| 25 | 10 |
| 26 | 10 |
| 27 | 9.9 |
| 28 | 9.8 |
| 29 | 9.7 |
| 30 | 9.5 |
| 31 | 9 |
| 32 | 8 |
| 33 | 5 |
| 34 | 2 |

To meet the link budget requirements for a given distance between the transmitter and the receiver, there may be a combination of gain settings for the baseband processor subsystem (106), the DFE subsystem (108), and the RFFE subsystem (110). In accordance with embodiments of the present disclosure, the controller (102) adaptively identifies the optimal combination of gain setting for the baseband processor subsystem (106), the DFE subsystem (108), and the RFFE subsystem (110). When the individual subsystems are tuned to deliver the least EVM, the combined EVM may be the least and the most desirable configuration.

In accordance with embodiments of the present disclosure, in order to achieve adaptive transmit power control, the controller (102) may set a power level of the baseband signal at the baseband processor subsystem (106), a power level of a DFE RF signal at the DFE subsystem (108), and a gain of a variable gain amplifier (VGA) at the RFFE subsystem (110). In an embodiment, the controller (102) may optimize the transmit power of the radio transceiver system (100) based on adaptively controlling the power level of the baseband signal, the power level of the DFE RF signal, and the gain of the VGA to meet a target EVM for a corresponding MCS value.

It may be appreciated that although the system architecture depicts a single antenna system, the embodiments of the present disclosure may be applicable for multiple input multiple output (MIMO) systems, and the controller (102) may perform similar techniques for each transmit path. In some embodiments, the embodiments of the present disclosure may be implemented with respect to Wi-Fi unlicensed band radio.

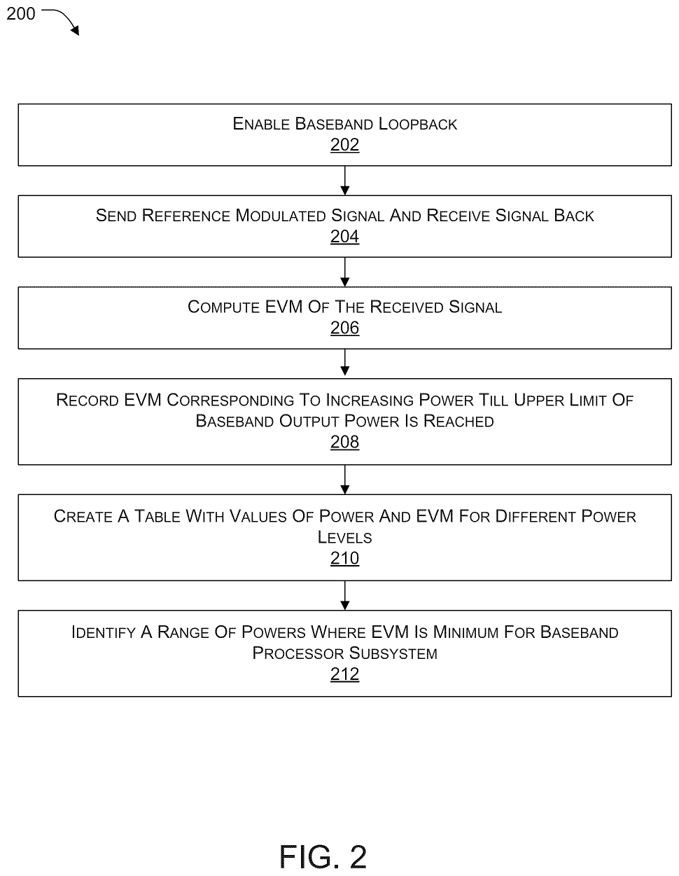

FIG. 2 illustrates a flow diagram of an example method (200) for determining an optimal gain setting to minimize EVM for a baseband processor subsystem (106), in accordance with an embodiment of the present disclosure.

Referring to FIG. 2, at block 202, the method (200) may include enabling baseband loopback. At block 204, the method (200) may include sending a reference modulated signal with power (P_{BB-0}) from a physical (PHY) processing module of the baseband processor subsystem (106). In an embodiment, the method (200) may include receiving the signal back into the PHY processing module. P_{BB-0} is the minimum power output from the baseband processor subsystem (106) where EVM is within acceptable limit.

At block 206, the method (200) may include computing the EVM of the signal received through the loopback path, and recording the EVM (EVM_{BB-0}). In an embodiment, a loopback signal receiving from output of a power amplifier (PA) (in RFFE subsystem (110)) is also utilized in addition to the signal received from the loopback path (P_{BB-0}). Loopback signal is received from output of the PA (in RFFE subsystem (110)) via a coupler.

At block 208, the method (200) may include increasing the power level in steps till the upper limit of the baseband output power (P_{BB-MAX}) is reached, and recording the EVM. In an embodiment, the power level is increased in steps of 0.25 dB. It may be appreciated that the power level may be increased in different step sizes within the scope of the present disclosure. In an embodiment, the EVM is recorded as given below:

For i=1 to n−1, where P_{BB-i}=P_{BB-0}+n*0.25, record the EVM; P_{BB-(n-1)}, <=P_{BB-max} Power level=P_{BB-i}, EVM=EVM_{BB-i}

Referring to FIG. 2, at block 210, the method (200) may include creating a table with values of power (P_{BB}) and EVM (EVM_{BB}) for different power levels. In an embodiment, the table may be stored in the memory (104). At block 212, the method (200) may include identifying a range of powers where the EVM is minimum for the baseband processor subsystem (106).

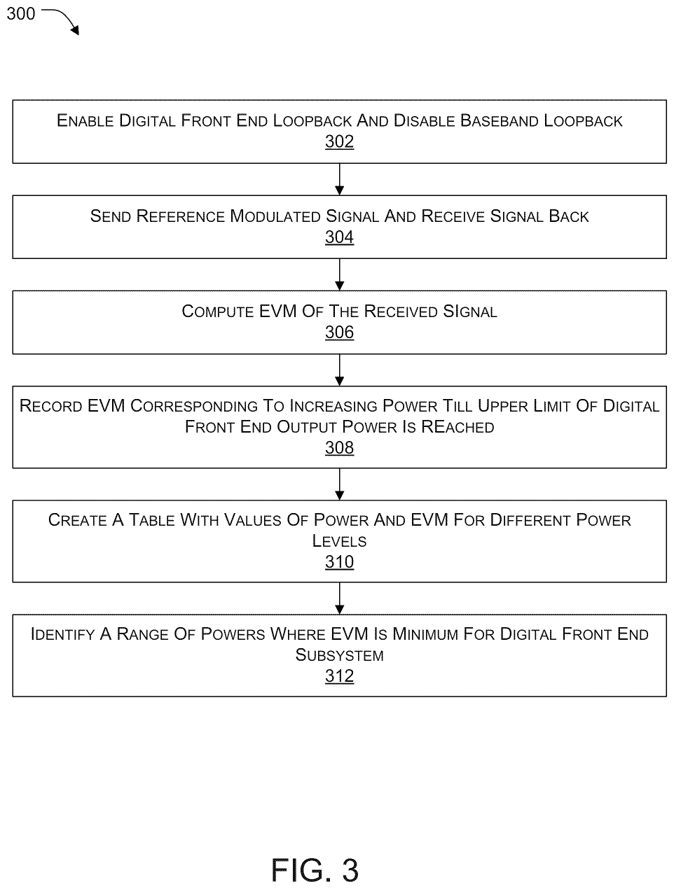

FIG. 3 illustrates a flow diagram of an example method (300) for determining an optimal gain setting to minimize EVM for a DFE subsystem (108), in accordance with an embodiment of the present disclosure.

Referring to FIG. 3, at block 302, the method (300) may include enabling DFE loopback and disabling baseband loopback. At block 304, the method (300) may include sending a reference modulated signal with power (P_{DFE-0}) from a PHY processing module. In an embodiment, the method (300) may include receiving the signal back into the PHY processing module. P_{DFE-0} is the minimum power output from the DFE subsystem (108) where EVM is within acceptable limit.

At block 306, the method (300) may include computing the EVM of the signal received through the loopback path, and recording the EVM (EVM_{DFE-0}). At block 308, the method (300) may include increasing the power level in steps till the upper limit of the DFE output power (P_{DFE-MAX}) is reached, and recording the EVM.

In an embodiment, the power level is increased in steps of 0.25 dB. It may be appreciated that the power level may be increased in different step sizes within the scope of the present disclosure. In an embodiment, the EVM is recorded as given below:

For i=1 to n-1, where P_{DFE-i}=P_{DFE-0}+n*0.25, record the EVM; P_{DFE-(n-1)}, <=P_{DFE-max}
Power level=P_{DFE-i}, EVM=EVM_{DFE-i}

Referring to FIG. 3, at block 310, the method (300) may include creating a table with values of power (P_{DFE}) and EVM (EVM_{DFE}) for different power levels. In an embodiment, the table may be stored in the memory (104). At block 312, the method (300) may include identifying a range of powers where the EVM is minimum for the DFE subsystem (108).

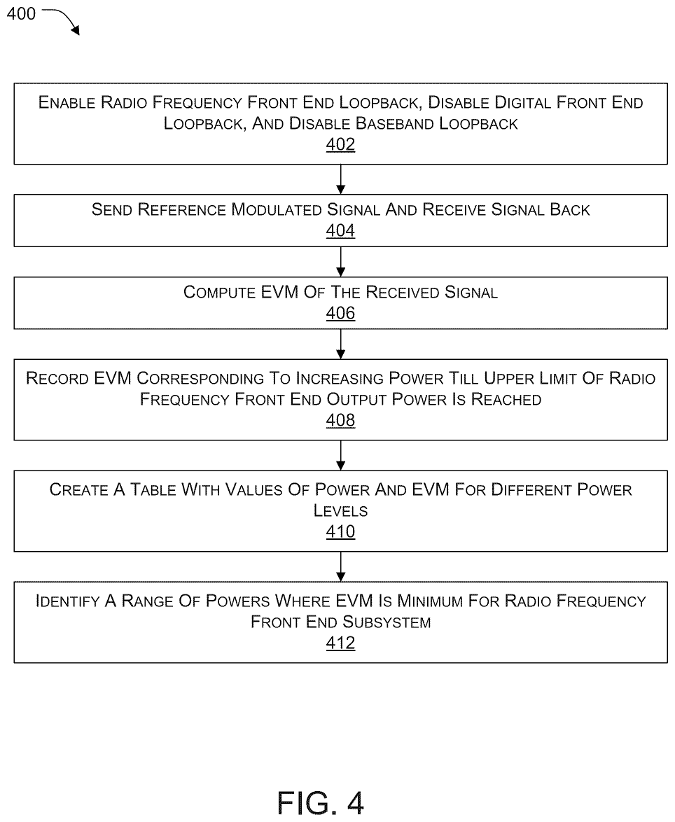

FIG. 4 illustrates a flow diagram of an example method (400) for determining an optimal gain setting to minimize EVM for a RFFE subsystem (110), in accordance with an embodiment of the present disclosure.

Referring to FIG. 4, at block 402, the method (400) may include

enabling RFFE loopback, setting VGA gain as 0 dB, disabling DFE loopback, and disabling baseband loopback. At block 404, the method (400) may include sending a reference modulated signal with power (P_{RFFE-0}) from a PHY processing module. In an embodiment, the method (400) may include receiving the signal back into the PHY processing module. P_{RFFE-0} is the minimum power output from the RFFE subsystem (110) where EVM is within acceptable limit.

At block 406, the method (400) may include computing the EVM of the signal received through the loopback path, and recording the EVM (EVM_{RFFE-0}). At block 408, the method (400) may include increasing the power level in steps till the upper limit of the RFFE output power (P_{RFFE-MAX}) is reached, and recording the

EVM. In an embodiment, the power level is increased in steps of 0.25 dB. It may be appreciated that the power level may be increased in different step sizes within the scope of the present disclosure. In an embodiment, the EVM is recorded as given below:

For i=1 to n−1, where P_{RFFE-i}=P_{RFFE-0}+n*0.25, record the EVM; P_{RFFE-(n-1)}, <=P_{RFFE-max}
Power level=P_{RFFE-i}, EVM=EVM_{RFFE-i}

Referring to FIG. 4, at block 410, the method (400) may include creating a table with values of power (P_{RFFE}) and EVM (EVM_{RFFE}) for different power levels. In an embodiment, the table may be stored in the memory (104). At block 412, the method (400) may include identifying a range of powers where the EVM is minimum for the RFFE subsystem (110).

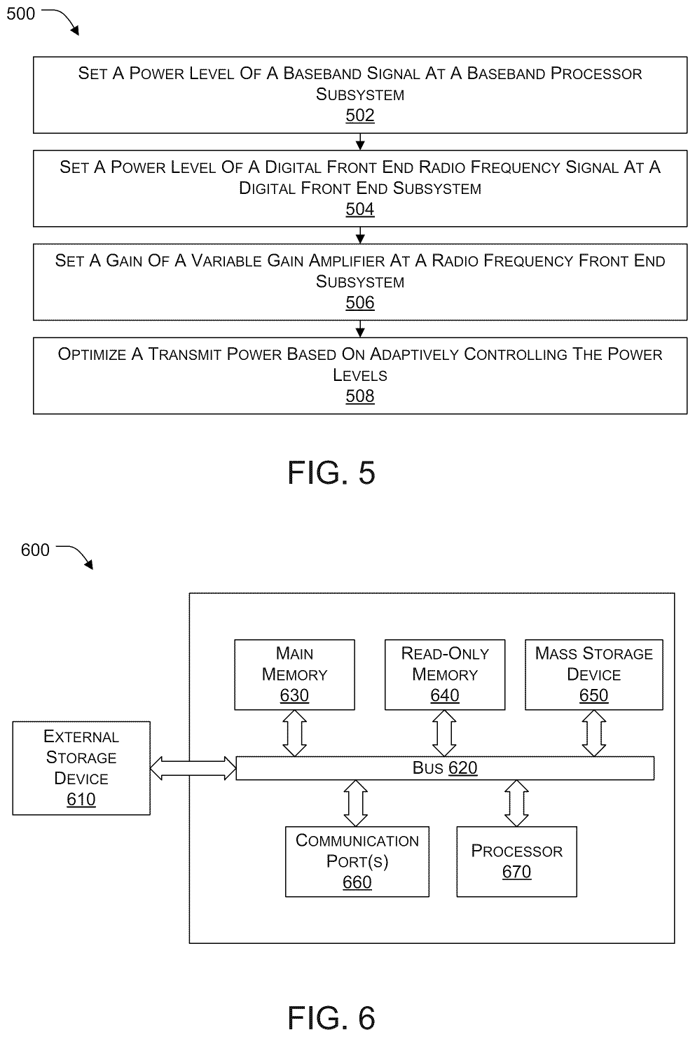

FIG. 5 illustrates a flow diagram of an example method (500) for adaptive transmit power control in a radio transceiver system (100), in accordance with an embodiment of the present disclosure.

The method (500) optimizes the gain settings to achieve best EVM performance for a given channel power setting. It may be appreciated that:

Channel power (dBm)=P_{ANT}
Number of subcarriers=N_{SC}
Power dynamic range of RF=10*log (N_{SC}); for example, for 80 MHz channel of 802.11AX based Wi-Fi channel, the power dynamic range is=10*log (996)=29.98 dB
Peak power of the channel, Pₚₑₐₖ=Average power+PAPR=P_{ANT}+PAPR

As the average power of the channel may vary over the dynamic range based on the radio resource utilization, ideally, every subsystem (baseband processor subsystem (106), DFE subsystem (108), RFFE subsystem (110)) should have a dynamic range of 29.98 dB or more. Ideally, the lowest EVM region should cover the entire dynamic range. As this may not be practically possible, the controller (102) may set the parameters for each subsystem, as discussed with reference to FIGS. 2-4.

Referring to FIG. 5, at block 502, the method (500) may include setting a power level of a baseband signal at the baseband processor subsystem (106) of the radio transceiver system (100). In an embodiment, the controller (102) may determine a range of power values at the baseband processor subsystem (106) where EVM is minimum, for example, via performing the method (200) of FIG. 2. The controller (102) may set the power level of the baseband signal as the highest power level in the range of power values corresponding to the minimum EVM. For example, if the baseband processor subsystem (106) has a power range of −15 dBm to −40 dBm as its lowest EVM zone where EVM is −45 dB, the controller (102) may set baseband power=−15 dBm. The baseband signal power may not have a bearing on the channel power depending on the implementation, but ensuring lowest EVM at the baseband processor subsystem (106) ensures best performance.

At block 504, the method (500) may include setting a power level of a DFE RF signal at the DFE subsystem (108) of the radio transceiver system (100). In an embodiment, the controller (102) may determine a range of power values at the DFE subsystem (108) where EVM is minimum, for example, by performing the method (300) of FIG. 3. The controller (102) may set the power level of the DFE RF signal as the highest power level in the range of power values corresponding to the minimum EVM. For example, if the DFE subsystem (108) has a power range of −10 dBm to −36 dBm as its lowest EVM zone where EVM is −45 dB, the controller (102) may set DFE power=−10 dBm.

At block 506, the method (500) may include setting a gain of a VGA at the RFFE subsystem (110) of the radio transceiver system (100). Typically, the RFFE subsystem (110) contains the VGA and a fixed gain driver and main amplifier. The VGA can attenuate or amplify the signal to adjust the configurable channel power. The VGA is expected to be very linear across the gain setting and channel frequency. With that consideration, assuming the effective fixed gain of the

RFFE subsystem (110) is g_{RFFE-fixed}. Assuming that the VGA has a gain range from g_{VGA_min} to g_{VGA_max} where g_{VGA_min} is negative in dB scale. The power at the antenna port is computed by the controller (102) as below:

$$Power at antenna port = channel power = {P}_{A N T} ( dBm ) = {P}_{DFE} + {g}_{VGA} + {g}_{RFFE - fixed} .$$

For example, if g_{RFFE-fixed}=30 dB, g_{VGA_min}=−10 dB, g_{VGA_min}=+10 dB, channel power=24 dBm, P_{DFE}=−10 dBm, the controller (102) may identify the VGA gain, as:

$${P}_{A N T} ( dBm ) = 24 = - 10 + {g}_{V G A} + 30 ; \text{=>} {g}_{V G A} = 4 dB$$

When the controller (102) sets g_{VGA}=4 dB, best EVM is expected for 24 dBm channel power. The peak power of the channel will be 24+PAPR. For example, MCS11 signal i.e. 256 QAM signal for an 80 MHz channel will have a PAPR of ˜12.5. The P1dB of the PA will determine the available power back off, which will impact the EVM value. As low EVM is expected for higher MCS values, the goal may be to set the maximum possible power that meets the EVM target. This is achieved by creating a RFFE characterization table 3.

TABLE 3

| Channel Power (dBm) | g_{VGA} (dB) | EVM (dB) |
|---|---|---|
| 24 | 4 | −30 |
| 23.5 | 3.5 | −31 |
| 23 | 3 | −35 |
| 22.5 | 2.5 | −38 |
| 22 | 2 | −49 |
| 21 | 1 | −50 |
| 20 | 0 | −52 |
| 18 | −2 | −55 |

As seen in the table 3 above, EVM improves as the channel power is reduced. The channel power is set by reducing the gain value of the VGA in step of 0.5 dB in this example. The controller (102) may choose a configurable step size for creating this table. As EVM of −35 dB is required for MCS11 to work, the maximum channel power that the radio transceiver system (100) can transmit is 23 dBm (as per this table). If the path loss between transmitter and receiver is low and the received power level is above the receiver sensitivity, the transmitter power can be reduced below 23 dBm to minimize power consumption and also to improve EVM.

Referring to FIG. 5, at block 508, the method (500) may include optimizing a transmit power of the radio transceiver system (100) based on adaptively controlling the power level of the baseband signal, the power level of the DFE RF signal, and the gain of the VGA to meet a target EVM for a corresponding MCS value. In an embodiment, the transmit power is based on at least the power level of the DFE RF signal, the gain of the VGA, and an effective fixed gain of the RF FE subsystem. In an embodiment, the controller (102) may increase the power level of the baseband signal. In an embodiment, the controller (102) may determine the transmit power for highest MCS value, compute available power headroom based on a receiver power value and a receiver sensitivity value for the corresponding MCS value, and modify the transmit power based on the available power headroom. In an embodiment, if the available power headroom for the highest MCS value is positive, the method (500) may include reducing the transmit power of the radio transceiver system (100) by increasing the power level of the baseband signal. In another embodiment, if the available power headroom for the highest MCS value is negative, the method (500) may include determining a maximum MCS value that meets the receiver sensitivity value, and dynamically optimizing the transmit power by modifying the power level of the baseband signal, the power level of the DFE RF signal, and the gain of the VGA.

For example, the controller (102) determines the power level for highest MCS to work by calculating the minimum power requirement. It may be appreciated that pathloss=PL and receiver sensitivity=P_{sensitivity}. As an example, if the PL=−60 dB, receiver sensitivity=−43 dB (for 80 Mhz, MCS11), Pᵣₓ=Pₜₓ+PL=24−60 =−36 dBm. Available power headroom=−36−(−43)=7 dB. Hence, the controller (102) may reduce the transmit power by 7 dB to meet the minimum power requirement at the receiver. If a margin of 2 dB is kept, the controller (102) may still reduce the transmit power by 5 dB to maximize EVM performance. Hence, the transmit power will be 24−5=19 dBm. This reduction in power is achieved by baseband power scaling while the gain settings of the DFE subsystem (108) and VGA remain the same. If the power headroom is negative for the highest MCS, the controller (102) may determine the maximum MCS that meets the receiver sensitivity. As an example, if PL=−80; Pᵣₓ=Pₜₓ+PL=24−80=−56 dBm. For this receive power level, highest possible MCS is 7 as per the receiver sensitivity table for 80 MHz channel. The controller (102) dynamically adapts the link for all the transceiver pairs to attain the maximum MCS value.

It may be appreciated that these steps of the method (500) may be performed during initialization of the radio transceiver system (100).

In an embodiment, during run time, the gain settings may be re-tuned based on changes in system parameters like temperature, channel power, channel frequency channel bandwidth, etc. The controller (102) monitors the link performance in real-time. Further, if the link performance reduces beyond some predefined threshold limit in the same environment, the controller (102) identify a condition to re-tune the gain settings. The controller (102) may also adaptively monitor the traffic conditions. In case of high traffic conditions, the controller (102) may postpone the re-tune the gain settings and wait for the low traffic conditions. The controller (102) may initialize the re-tuning (optimal gain setting) in low traffic conditions.

Accordingly, during run time, the method (500) may include monitoring link performance of the radio transceiver system (100), determining whether the link performance is below a predetermined threshold value, and in response to determining that the link performance is below the predetermined threshold value, identifying a condition to re-optimize the transmit power of the radio transceiver system (100), or in response to determining that the link performance exceeds the predetermined threshold value, continuing to monitor the link performance. In response to identifying the condition to re-optimize the transmit power, the method (500) may include monitoring a traffic condition corresponding to the radio transceiver system (100), determining whether the traffic condition is below a traffic threshold value, and in response to determining that the traffic condition is below the traffic threshold value, re-optimizing the transmit power of the radio transceiver system (100) based on steps of the method (500) discussed above, or in response to determining that the traffic condition exceeds the traffic threshold value, continuing to monitor the traffic condition.

It may be appreciated that the steps of the methods (200, 300, 400, 500) may be performed by the controller (102). As shown in FIG. 1, the controller (102) may be operatively couple to the memory (104). The memory (104) may include controller-executable instructions which, when executed by the controller (102), may cause the controller (102) to perform the methods (200, 300, 400, 500).

FIG. 6 illustrates an example computer system (600) in which or with which embodiments of the present disclosure may be implemented.

The blocks of the flow diagrams shown in FIGS. 2-5 have been arranged in a generally sequential manner for ease of explanation; however, it is to be understood that this arrangement is merely exemplary, and it should be recognized that the processing associated with methods (200, 300, 400, 500) may occur in a different order (for example, where at least some of the processing associated with the blocks is performed in parallel and/or in an event-driven manner). Further, it may be appreciated that the steps shown in FIGS. 2-5 are merely illustrative. Other suitable steps may be used for the same, if desired. Moreover, the steps of the method (200, 300, 400, 500) may be performed in any order and may include additional steps.

The methods and techniques described herein may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, FPGA, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system, explained in detail with reference to FIG. 6, including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), and flash memory devices; magnetic disks such as internal hard disks and removable disks; and magneto-optical disks. Any of the foregoing may be supplemented by, or incorporated in, specially designed application-specific integrated circuits (ASICs).

In particular, FIG. 6 illustrates an exemplary computer system (600) in which or with which embodiments of the present disclosure may be utilized. The computer system (600) may be implemented as or within the radio transceiver system (100) described in accordance with embodiments of the present disclosure.

As depicted in FIG. 6, the computer system (600) may include an external storage device (610), a bus (620), a main memory (630), a read-only memory (640), a mass storage device (650), communication port(s) (660), and a processor (670). A person skilled in the art will appreciate that the computer system (600) may include more than one processor (670) and communication ports (660). The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication port(s) (660) may be chosen depending on a network, such a Local Area Network (LAN), Wide Area Network (WAN), or any network to which the computer system (600) connects.

In an embodiment, the main memory (630) may be Random Access Memory (RAM), or any other dynamic storage device commonly known in the art. The read-only memory (640) may be any static storage device(s) e.g., but not limited to, a Programmable Read Only Memory (PROM) chips for storing static information e.g., start-up or basic input output system (BIOS) instructions for the processor (670). The mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) communicatively couples the processor (670) with the other memory, storage, and communication blocks. The bus (620) may be, e.g., a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (670) to the computer system (600).

In another embodiment, operator and administrative interfaces, e.g., a display, keyboard, and a cursor control device, may also be coupled to the bus (620) to support direct operator interaction with the computer system (600). Other operator and administrative interfaces may be provided through network connections connected through the communication port(s) (660). Components described above are meant only to exemplify various possibilities. In no way should the aforementioned exemplary computer system (600) limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a system and a method thereof for adaptive transmit power control.

The present disclosure facilitates to achieve highest Modulation and Coding Scheme (MCS) value while meeting the spectrum emission mask.

The present disclosure provides an optimal gain setting at each subsystem level and arrives at the most optimal trade-off between the transmit power level and error vector magnitude (EVM) for the highest achievable MCS value.

The present disclosure facilitates the system to linearize amplifiers at different subsystem levels so that same power level can be maintained preferably for all MCS.

The present disclosure provides an intelligent power management mechanism to enhance spectrum efficiency without violating the spectrum emission mask and attaining highest MCS value.

We claim:

1. A method for adaptive transmit power control in a radio transceiver system, the method comprising:
setting, by a controller associated with the radio transceiver system, a power level of a baseband signal at a baseband processor subsystem of the radio transceiver system;
setting, by the controller, a power level of a digital frontend (DFE) radio frequency (RF) signal at a DFE subsystem of the radio transceiver system;
setting, by the controller, a gain of a variable gain amplifier (VGA) at a RF FE subsystem of the radio transceiver system; and
optimizing, by the controller, a transmit power of the radio transceiver system based on adaptively controlling the power level of the baseband signal, the power level of the DFE RF signal, and the gain of the VGA to meet a target error vector magnitude (EVM) for a corresponding modulation and coding scheme (MCS) value.

2. The method as claimed in claim 1, wherein the transmit power is based on at least the power level of the DFE RF signal, the gain of the VGA, and an effective fixed gain of the RF FE subsystem.

3. The method as claimed in claim 1, wherein optimizing, by the controller, the transmit power comprises increasing, by the controller, the power level of the baseband signal.

4. The method as claimed in claim 1, wherein optimizing, by the controller, the transmit power comprises:
determining, by the controller, the transmit power for highest MCS value;
computing, by the controller, available power headroom based on a receiver power value and a receiver sensitivity value for the corresponding MCS value; and
modifying, by the controller, the transmit power based on the available power headroom.

5. The method as claimed in claim 4, wherein, if the available power headroom for the highest MCS value is positive, the method comprises reducing, by the controller, the transmit power of the radio transceiver system by increasing the power level of the baseband signal.

6. The method as claimed in claim 4, wherein, if the available power headroom for the highest MCS value is negative, the method comprises:
determining, by the controller, a maximum MCS value that meets the receiver sensitivity value; and
dynamically optimizing, by the controller, the transmit power by modifying the power level of the baseband signal, the power level of the DFE RF signal, and the gain of the VGA.

7. The method as claimed in claim 1, wherein the method is performed during initialization of the radio transceiver system.

8. The method as claimed in claim 1, wherein setting, by the controller, the power level of the baseband signal comprises:
determining, by the controller, a range of power values at the baseband processor subsystem where EVM is minimum; and
setting, by the controller, the power level of the baseband signal as the highest power level in the range of power values corresponding to the minimum EVM.

9. The method as claimed in claim 1, wherein setting, by the controller, the power level of the DFE RF signal comprises:
determining, by the controller, a range of power values at the DFE subsystem where EVM is minimum; and
setting, by the controller, the power level of the DFE RF signal as the highest power level in the range of power values corresponding to the minimum EVM.

10. The method as claimed in claim 1, further comprising:
monitoring, by the controller, link performance of the radio transceiver system;
determining, by the controller, whether the link performance is below a predetermined threshold value; and
in response to determining that the link performance is below the predetermined threshold value, identifying, by the controller, a condition to re-optimize the transmit power of the radio transceiver system; or
in response to determining that the link performance exceeds the predetermined threshold value, continuing, by the controller, to monitor the link performance.

11. The method as claimed in claim 10, wherein, in response to identifying, by the controller, the condition to re-optimize the transmit power, the method further comprises:
monitoring, by the controller, a traffic condition corresponding to the radio transceiver system;
determining, by the controller, whether the traffic condition is below a traffic threshold value; and
in response to determining that the traffic condition is below the traffic threshold value, re-optimizing, by the controller, the transmit power of the radio transceiver system; or in response to determining that the traffic condition exceeds the traffic threshold value, continuing, by the controller, to monitor the traffic condition.

12. The method as claimed in claim 10, wherein the method is performed during run time of the radio transceiver system.

13. A system for adaptive transmit power control, the system comprising:
a controller; and
memory operatively coupled to the controller, wherein the memory comprises instructions which, when executed by the controller, cause the controller to:
set a power level of a baseband signal at a baseband processor subsystem of the system;
set a power level of a digital frontend (DFE) radio frequency (RF) signal at a DFE subsystem of the system;
set a gain of a variable gain amplifier (VGA) at a RF FE subsystem of the system; and
optimize a transmit power of the system based on adaptively controlling the power level of the baseband signal, the power level of the DFE RF signal, and the gain of the VGA to meet a target error vector magnitude (EVM) for a corresponding modulation and coding scheme (MCS) value.
